(19) United States
(12) Patent Application Publication
(10) Pub. No.: US 2026/0115074 A1
(43) Pub. Date: Apr. 30, 2026

(54) Shell for an HBOT Hyperbaric Chamber

(71) Applicant: 3G Medical GmbH, Dornbirn (AT)

(72) Inventors: Thomas Gotwald, Dornbirn (AT); Markus Gotwald, Dornbirn (AT); Andreas Gotwald, Dornbirn (AT); Uro Miletic, DornBirn (AT)

(21) Appl. No.: 19/483,360

(22) PCT Filed: May 10, 2024
(86) PCT No.: PCT/AT2024/060202

§ 371 Date: Nov. 11, 2025

(30) Foreign Application Priority Data
May 11, 2023 (AT) A50366/2023

(51) Int. Cl. A61G 10/02

(52) U.S. Cl. CPC A61G 10/026; A61G 2200/34

(57) ABSTRACT

The invention relates to a shell (1) for forming a pressurised part of a HBOT hyperbaric chamber (2), and relates to a HBOT hyperbaric chamber (2) for performing hyperbaric oxygen therapy for a person at an operating pressure of 1.3 to 2 bar positive pressure, wherein a shell-like support lattice (3) is provided;—wherein the support lattice (3) comprises a plurality of support strips (4) extending along the shell shape and a plurality of free openings (5) between the support strips (4);—wherein a transparent window shell (6) is provided which is held on its outer face by the support lattice (3) and pressure-tightly covers the openings (5) in the support lattice (3), in particular all the openings (5) of the support lattice (3).

The invention relates to a shell and an HBOT hyperbaric chamber according to the features of the independent claims.

HBOT hyperbaric chambers are hyperbaric chambers for administering hyperbaric oxygen therapy to an individual. “Hyperbaric oxygen therapy” (HBOT) has been known since around 1960 and has its origins in the treatment of decompression sickness. HBOT is a medical treatment method in which individuals or patients inhale nearly 100% pure oxygen under controlled whole-body hyperbaric pressure for medically defined periods of time.

By combining nearly 100% pure oxygen with the simultaneous application of overpressure, it is possible to achieve oxygen partial pressures (pO₂; “oxygen doses”) in the blood and tissues of the individual that cannot be attained by administering pure oxygen alone or by overpressure alone.

These elevated oxygen partial pressures (pO₂) have a variety of direct and indirect effects on the human body. Most of these effects help to alleviate or cure diseases and for certain conditions they are essentially the only treatment method (such as smoker's leg). In practice, it has been found that the beneficial effect of the treatment occurs only at a chamber internal pressure exceeding 1 bar overpressure, in particular between 1.3 and 2 bar overpressure. Accordingly, a distinction must be made between HBOT hyperbaric chambers capable of operating at a pressure of about 1.3 to about 2 bar above ambient pressure and conventional oxygen therapy devices, which operate at a lower overpressure of less than 1 bar, in particular between 0.3 and 0.5 bar.

HBOT hyperbaric chambers and oxygen therapy devices are known in the art and are described in various embodiments. For example, overpressure chambers are known that are constructed similarly to a steel pressure tank, with a cylindrical space for multiple persons being sealed on both sides by flange connections with cover caps. Such chambers are generally very bulky and have a large mass, which significantly restricts their transportability and the choice of possible installation locations. Additionally, in practice, the problem arises that persons located in the chamber may experience an adverse subjective sensation—for example claustrophobia—when required to spend several minutes in a closed steel tank.

As an alternative to such steel-tank type devices for multiple individuals, smaller tubes are known, in which the person is lying. These smaller chambers offer improved transportability, however, the sense of space for the person is further impaired by the narrowness of the space, which again may, for example, lead to claustrophobia. For this reason, it is known to install observation windows in the smaller tubes so that the person at least has some outside view.

Especially for persons with limited mobility, it is often not possible to enter such a tube in a lying position. In addition, a lying position of the person during therapy is often medically undesirable.

In simple oxygen therapy devices operating at an overpressure of less than 1 bar, improved transportability and a better sense of space may be achieved; however, such devices do not enable hyperbaric oxygen therapy in the sense of the present invention.

The object of the invention is to overcome the disadvantages of the state of the art.

In particular, it is an object of the invention to provide an HBOT hyperbaric chamber for hyperbaric oxygen therapy operating at an overpressure of 1.3 to 2 bar, without having to accept the limitations of the prior art.

For example, the HBOT hyperbaric chamber should be easily transportable for use in conventional buildings. Further, the chamber should allow a person with limited mobility to enter and exit easily. Further, it is intended that the person experiences a sufficiently pleasant sense of space during the treatment. This conflict of objectives is in particular solved by the features of the independent claims.

In particular, the invention relates to a shell for forming a pressurised part of an HBOT hyperbaric chamber, namely an HBOT hyperbaric chamber (2) for performing hyperbaric oxygen therapy for a person at an overpressure of 1.3 to 2 bar.

Preferably, a shell-shaped support lattice is provided.

Preferably, the support lattice has a plurality of support strips extending along the shell shape and a plurality of openings are kept free between the support strips.

Preferably, a transparent window shell is provided, which is held on its outer face by the support lattice and pressure-tightly covers the openings of the support lattice, in particular every opening of the support lattice.

Preferably, the window shell is configured as a continuous shell-shaped window shell.

Preferably, the window shell is adapted to the shape of the support lattice and extends along the shell shape of the support lattice.

Optionally, it is provided that the window shell, on its outer face, is supported on the support lattice along the support strips against a pressure force acting on the inside of the window shell.

Optionally, it is provided that a functional ring is provided at the edge of the shell, on which the edge of the support lattice engages.

Optionally, it is provided that the window shell and the support lattice protrude from the functional ring on one side.

Preferably, it is provided that within the shell-shaped composite structure comprising the functional ring, window shell and support lattice, a shell interior space is kept clear.

Optionally, it is provided that, in the region of the functional ring, the shell interior space has a free interior space of at least 110 cm×110 cm, preferably 130 cm×130 cm. In the present case, this dimension is defined as a square enclosed within the shell interior space.

Optionally, it is provided that, in the region of the functional ring, the shell interior space has a free inner diameter of at least 160 cm, preferably 180 cm.

Optionally, it is provided that the shell has an outer contour in at least one direction, which is smaller than a rectangle having dimensions of 80 cm×200 cm.

Optionally, it is provided that the shell is dimensioned in such a way that it passes through a rectangular opening having dimensions of 80 cm×200 cm.

Optionally, it is provided that the support strips of the support lattice extend in a basket-like pattern.

Optionally, it is provided that the support strips of the support lattice extend in a star-shaped pattern.

Optionally, it is provided that the support strips of the support lattice extend along planes of symmetry of the shell shape.

Optionally, it is provided that the shell has the form of a body of revolution or of a part of a body of revolution.

Optionally, a sealing assembly is provided. In particular, the sealing assembly is provided on the functional ring.

Optionally, it is provided that the window shell, the support lattice, the functional ring and the sealing assembly together form a composite that bears the overpressure of the HBOT hyperbaric chamber.

Optionally, it is provided that the window shell is a shell-shaped laminated pane.

Optionally, it is provided that it is configured as a door to an HBOT hyperbaric chamber.

In particular, the invention relates to an HBOT hyperbaric chamber operating at a overpressure of 1.3 to 2 bar, the pressurised part of the shell being configured according to the specification.

Optionally, a source of overpressure is provided, such as in particular a compressor, for generating an operating pressure of the HBOT hyperbaric chamber ranging from 1.3 to 2 bar overpressure. In particular, a source of overpressure, such as in particular a compressor, is provided for generating an operating pressure of the HBOT hyperbaric chamber of 1.3 to 2 bar overpressure.

Optionally, a seat arranged or arrangeable inside the HBOT hyperbaric chamber is provided for the seated positioning of a person inside the HBOT hyperbaric chamber.

Optionally, an oxygen source, an oxygen delivery device, in particular an oxygen mask, and an oxygen line conducting oxygen from the oxygen source to the oxygen delivery device are provided.

Optionally, it is provided that the oxygen source is arranged outside of the HBOT hyperbaric chamber.

Optionally, the oxygen source comprises or is an oxygen concentrator that extracts oxygen from ambient air. Optionally, the oxygen source is an existing local oxygen source, for example the oxygen supply of a hospital. Optionally, the oxygen source is an oxygen cylinder.

Optionally, it is provided that the oxygen delivery device, in particular the oxygen mask, is arranged inside the HBOT hyperbaric chamber.

Optionally, it is provided that the oxygen line runs from the oxygen source through the shell, in particular the functional ring of the shell, to the oxygen delivery device.

Optionally, it is provided that the oxygen source and the oxygen line deliver oxygen within the HBOT hyperbaric chamber exclusively via the oxygen delivery device, preferably directly to the mouth and/or nose of the person located in the HBOT hyperbaric chamber.

Optionally, it is provided that the HBOT hyperbaric chamber and the shell withstand a test pressure of at least 2.86 bar overpressure and/or are designed for a test pressure of at least 2.86 bar overpressure.

Optionally, it is provided that a base module is provided, on which the shell is movably mounted.

Optionally, two shells are provided, the two shells, in particular their functional rings, being connected in a sealing manner to form the HBOT hyperbaric chamber.

The present construction is able to overcome the disadvantages of conventional single-person HBOT chambers and especially allows mobility-restricted or injured persons to access and use the HBOT chamber.

The shell and/or the HBOT hyperbaric chamber preferably have the following features and advantages:
Reduced weight of the HBOT hyperbaric chamber due to the use of 2 plastic half-shells that together form the window shells. Optionally, the window shell also comprises a film, so that a laminated pane is formed.
Pressure distribution onto the two half-shells via thin (designated) support strips made of a rigid material, for example metal.
Lightweight modular construction of the HBOT chamber; at most 500 kg, preferably at most 350 kg total weight.
Convenient entry via the shell opening. This is advantageous and necessary for injured or mobility-restricted persons.
Displaceable seat for safe entry/exit of patients into and out of the chamber.
Transparent construction to avoid claustrophobia in the HBOT chamber.
Transparent construction to enable secure visual monitoring of the person in the chamber.
Orthopaedic function of the seat for individual patient adaptation.

In order to easily and safely transfer persons from hospital chairs to the chamber seat, the seat may preferably be movable via a sliding or pivoting system into a position outside the chamber that is optimized for the person. The mechanism may be anchored in the end positions by means of force packs (spring packs) to optionally relieve the drive. This allows for the use of light and compact drives. The location/position/inclination of the seat is optionally adjustable via a control console.

Preferably, the seat is configured to be pivotable, providing the ability to move the seat into a comfortable position to perfectly accommodate the patient's needs.

In order to be able to load the HBOT hyperbaric chamber with an overpressure of 1.3 to 2 bar, the shell is preferably locked multiple times in a pressure-tight manner along the functional ring. Preferably, the locks are arranged and distributed along the functional ring. Preferably, the support strips engage the functional ring in the regions, in which the locks are also provided. Preferably, the support strips thus engage in the regions of the locks.

The HBOT hyperbaric chamber is pressurised to a defined overpressure via a source of overpressure, in particular one that is externally installed. In all embodiments, the HBOT hyperbaric chamber is preferably pressurised using normal (ambient) air.

Optionally, the HBOT hyperbaric chamber is equipped with ventilation. The ventilation throughput may be, for example, 50-100 litres per minute, preferably about 80 litres per minute. The ventilation may be effected via the source of overpressure. At a ventilation rate of 80 l/min, a total air volume of 1800 litres at 1.5 bar and 2400 litres at 2 bar, and a human body volume of about 100 litres, changes in the air composition inside the chamber are negligible.

Preferably, the source of overpressure comprises a compressor. The compressor may have two sets of air filters, for example 0.05 and 0.01 micrometres. For example, the compressor may have a flow rate of 100 l/min.

The oxygen mask in the chamber is supplied with oxygen via an oxygen source, which is preferably installed outside. Depending on the required chamber pressure, 1 or 2 oxygen sources are operated in parallel.

As a patient generates approximately 100 W of heat in a resting position, a climate-control module is preferably provided outside the chamber to cool the air in the chamber.

In all embodiments, it is preferably provided that the HBOT hyperbaric chamber is approved as a medical device. Preferably, it is provided that the HBOT hyperbaric chamber withstands a test pressure of at least 2.86 bar overpressure and/or is designed for a test pressure of at least 2.86 bar overpressure.

The support lattice or its support strips may be formed from a flat semi-finished product deformed in a shell-shaped manner, for example from a plate, such as in particular a thin metal plate. Preferably, the openings of the support lattice are formed by recesses in the semi-finished product or the sheet. Optionally, a steel plate may be provided with the openings. In a next step, the shell shape of the support lattice may be produced in a cavity by deep drawing or pressing.

Optionally, the support lattice is formed from a high-tensile material, as for example steel or another metal alloy. In the following, some examples for suitable metals or metal alloys are mentioned: Stainless steel, chromium-nickel steel, preferably S700MC (in accordance with DIN EN 10149-2), hardened structural steel, or aluminium alloy.

Optionally, the support lattice is formed from a fibrous composite material, such as GFRP or CFRP, the shell-shaped design being produced by placing fibres or fibre mats into a shell-shaped mould and subsequent curing. The openings may be left out during the placing process.

Optionally, the window shell may be formed from a flat semi-finished product or a plate or pane, which is then domed into a shell shape. For example, the window shell may be formed from a transparent plastic, such as PMMA, acrylic glass and/or polycarbonate.

The invention is further described below with reference to the figures.

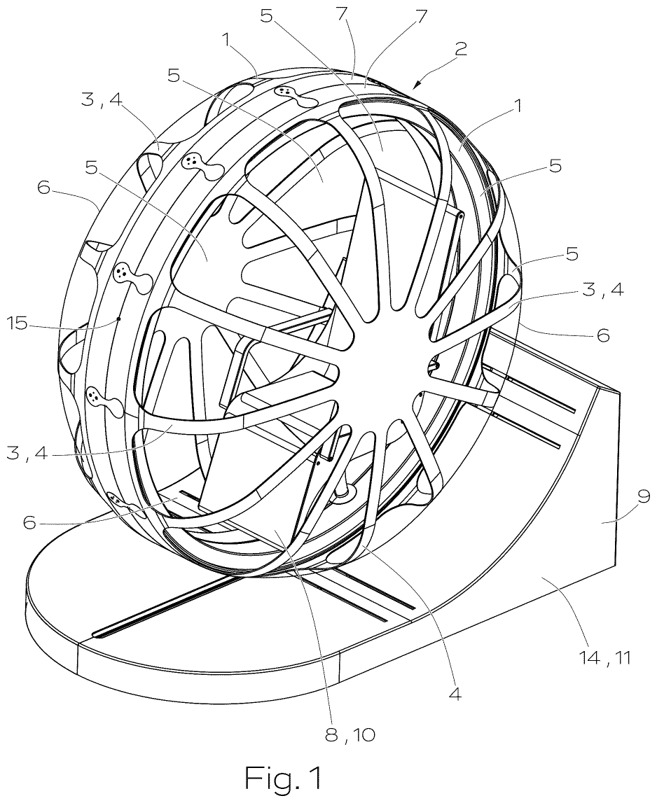

FIG. 1 shows a schematic oblique view of a potential embodiment of an HBOT hyperbaric chamber having two shells.

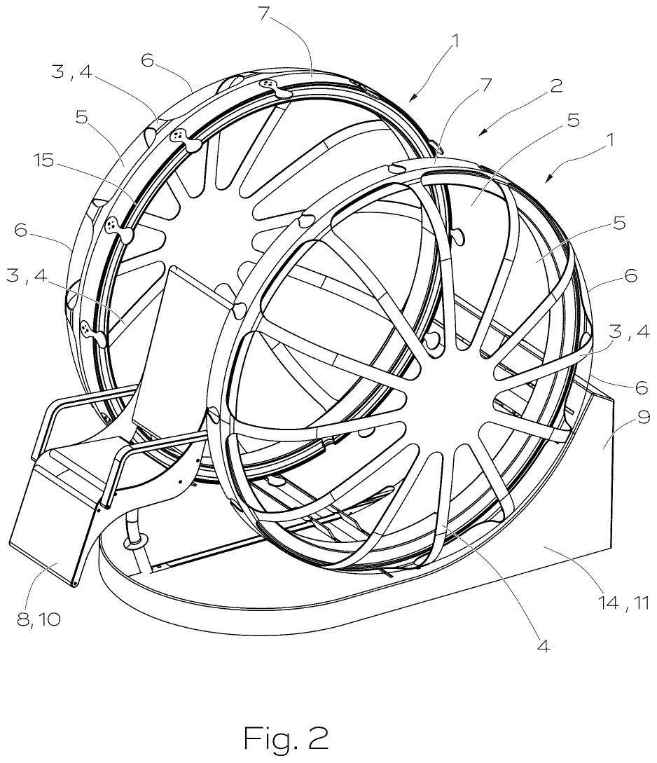

FIG. 2 shows the device of FIG. 1, however, in an open position.

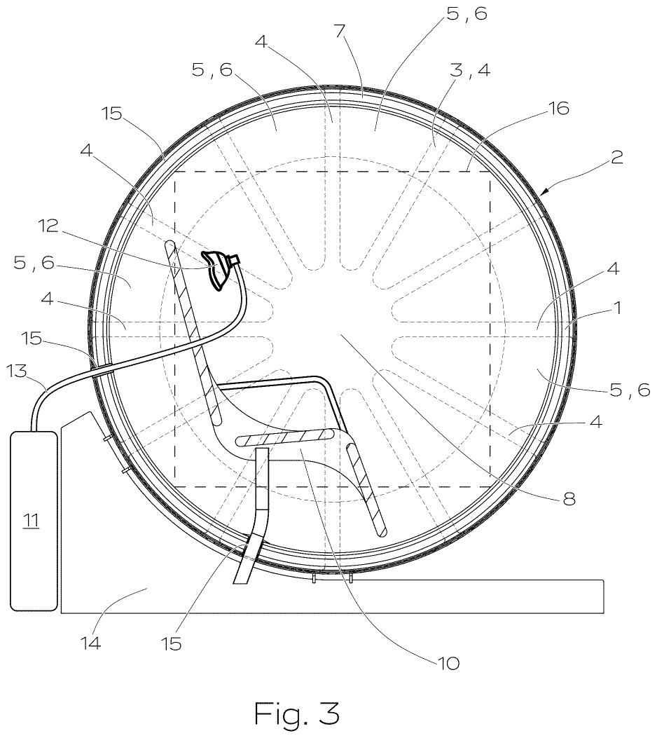

FIG. 3 shows a schematic sectional view of an HBOT hyperbaric chamber.

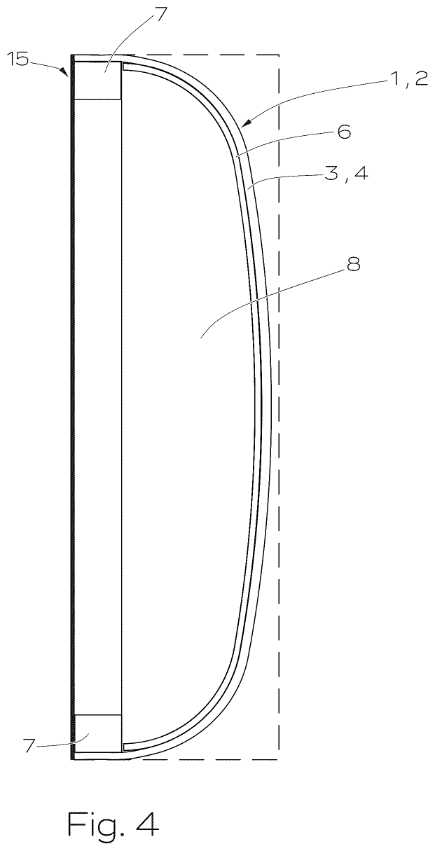

FIG. 4 shows a schematic sectional view of details of a shell.

Unless otherwise indicated, the reference numbers correspond to the following components: shell 1, HBOT hyperbaric chamber 2, support lattice 3, support strip 4, opening 5, window shell 6, functional ring 7, shell interior space 8, source of overpressure 9, seat 10, oxygen source 11, oxygen delivery device 12, oxygen line 13, base module 14, sealing assembly 15, square 16.

FIG. 1 shows a schematic oblique view of a potential embodiment of an HBOT hyperbaric chamber 2 having two shells 1. In particular, two shells 1 are provided that, when assembled, form an HBOT hyperbaric chamber 2 or at least delimit it.

Shell 1 comprises a support lattice 3. The support lattice 3 comprises a plurality of support strips 4. In particular, the support lattice 3 is composed of a plurality of support strips 4. The support strips 4 and in particular the entire support lattice 3 are shell-shaped.

A plurality of openings 5 between the support strips 4 are kept free. These openings 5 allow a person inside the chamber to look out at the surroundings. To still be able to build up an overpressure in the HBOT hyperbaric chamber 2, these openings 5 are sealed by a window shell 6. Preferably, the window shell 6 is configured to be transparent.

Preferably, a single window shell 6 is provided for each shell 1, which seals all openings 5 of the support lattice 3. For example, the window shell 6 may be formed in one piece. However, the window shell 6 may optionally also be formed from multiple pieces. Preferably, it is provided that a window shell 6 is provided for each shell 1.

Shell 1 comprises a functional ring 7. Preferably, the functional ring 7 is a closed annular body. The edge of the support lattice 3 engages with the functional ring 7. In particular, the support strips 4 run along a shell-shaped form that extends on one side away from the functional ring 7.

In the present embodiment, two shells 1 are provided, each comprising a functional ring 7. In the closed position shown in FIG. 1, the two functional rings 7 are pressed against one another and sealed with respect to each other.

A free shell interior space 8 is provided inside the functional ring 7. The shell interior space 8 is delimited by shell 1 or by shells 1.

In the present embodiment, a base module 14 is provided. The base module 14 supports shell 1.

A source of overpressure 9 to increase the pressure in the shell interior space 8 is provided. The source of overpressure 9 may, for example, be a compressor. Optionally, the source of overpressure 9 may be provided within the base module 14. According to a preferred embodiment, the source of overpressure 9 may be arranged at a location remote from the HBOT hyperbaric chamber 2, so that any noise emissions originating from the source of overpressure 9 are not perceived as disturbing by the person to be treated. Preferably, a line is provided that connects the source of overpressure 9 to the shell interior space 8 of the shell in order to increase the pressure in the shell interior space 8, in particular to increase it to an overpressure of 1.3-2 bar.

In the position in FIG. 1, a seat 10 is arranged inside the shell interior space 8. The seat 10 is for example an adjustable seat, which enables a person to be positioned in a seated or reclined position.

Further, the HBOT hyperbaric chamber 2 comprises an oxygen source 11. The oxygen source 11 is adapted to deliver substantially pure oxygen to the person. To this end, an oxygen delivery device 12 and an oxygen line 13 are provided, which, however, are not visible in the illustration in FIG. 1.

A sealing assembly 15 is provided for sealing the HBOT hyperbaric chamber 2. The sealing assembly 15 seals the components of the shell 1, such as for example the functional ring 7, the window shell 6, and the support lattice 3, with respect to each other. Further, the sealing assembly 15 also seals shell 1 with respect to other parts of the HBOT hyperbaric chamber 2.

FIG. 2 shows the HBOT hyperbaric chamber 2 of FIG. 1, however, in a further position. In this position, the HBOT hyperbaric chamber 2 is open. In particular, the two shells 1 are arranged at a distance from each other, so that a person can easily enter. In the present position, seat 10 is displaced, so that entry of a person is further facilitated. The seat 10 can be moved between the two shells 1 to close the HBOT hyperbaric chamber 2. Next, the shells 1 are closed, as shown in FIG. 1. The components of FIG. 2 are the same as shown and described in FIG. 1.

FIG. 3 shows a schematic sectional view of a possible embodiment of an HBOT hyperbaric chamber 2. For example, the chamber may be configured in the same way as the one described in FIGS. 1 and 2. The HBOT hyperbaric chamber 2 comprises a shell 1. Shell 1 is a pressurised part of the HBOT hyperbaric chamber 2. Shell 1 comprises a support lattice 3, which is composed of a plurality of support strips 4. Openings 5 are provided/kept free between the support strips 4. The openings 5 are sealed by a window shell 6.

At the edge of the shell 1, a functional ring 7 is provided and the edge of the support lattice 3 engages the functional ring 7. Inside the functional ring 7, a shell interior space 8 is kept clear. The shell interior space 8 is configured to accommodate a person during treatment. In all embodiments, the shell interior space 8 is preferably dimensioned in a way that a person may be seated within the HBOT hyperbaric chamber 2. In particular, a free space of at least 110 cm×110 cm, preferably about 130 cm×130 cm, is to be kept clear. The above-mentioned dimensions are sufficient to provide a person with adequate space while seated. In the present case, this dimension is defined as a square 16 enclosed within the shell interior space.

In the present embodiment, the shell interior space 8 is substantially circular and has an inner diameter of at least approximately 160 cm, preferably about 180 cm.

It would be desirable to make the chamber as large as possible in order to provide a pleasant sense of space for the person. However, this is not possible due to technical limitations such as, for example, pressure resistance or transportability. The dimension of the shell 1 is therefore preferably configured such that it can pass through a rectangular opening 5 having dimensions of 80 cm×200 cm. Preferably, the outer diameter of the shell 1 is less than or equal to 200 cm.

The HBOT hyperbaric chamber 2 comprises an oxygen source 11. The oxygen source 11 is adapted to supply the person with oxygen, in particular substantially pure oxygen. To this end, the oxygen source 11 is connected to the oxygen delivery device 12 via an oxygen line 13. Preferably, the oxygen delivery device 12 is an oxygen mask.

In all embodiments, it is preferably provided that the oxygen delivery device 12 is an oxygen mask sealingly connectable to the person's mouth and/or nose. The oxygen line 13 extends, in a substantially closed manner, through the shell interior space 8 of the HBOT hyperbaric chamber 2 to the oxygen delivery device 12. This prevents highly concentrated oxygen from entering the shell interior space 8 of the HBOT hyperbaric chamber 2. The oxygen line 13 is preferably routed through the functional ring 7 of the shell 1. The sealing assembly 15 seals the routing of the oxygen line 13.

Preferably, the person inside the HBOT hyperbaric chamber 2 is in a seated position. For this purpose, the device comprises a seat 10. The seat 10 may, for example, be supported on the base module 14 and extend with a seat pedestal through the shell 1 or through the connecting region between the shells 1. This region too may be sealed by the sealing assembly 15.

FIG. 4 shows a schematic sectional view of a shell 1. The shell 1 may, for example, be used in the devices according to FIGS. 1, 2, and/or 3. Shell 1 is a pressurised part of a HBOT hyperbaric chamber 2. Shell 1 comprises a support lattice 3, which is composed of a plurality of support strips 4. The sectional view runs exactly through a support strip 4, occluding the openings 5 provided between the support strips 4.

The shell 1 comprises a window shell 6. The window shell 6 is supported from the outside by the support lattice 3 against the pressure forces acting inside the shell interior space 8. In particular, the window shell 6 bears against the support lattice 3 from inside. The support lattice 3 thus supports the window shell 6 along the course of the support strips 4. Preferably, the support strips 4 bear along their extent against the outer side of the window shell 6.

By this design, a good outward view for the person can be achieved despite high pressure forces inside the HBOT hyperbaric chamber 2. To further improve stability and also to route any lines, functional ring 7 is provided. The functional ring 7 is a load-bearing element that, on the inside, defines a free shell interior space 8. The support lattice 3 and also the window shell 6 extend in a shell-shaped manner on one side away from the functional ring 7. A sealing assembly 15 serves to seal the shell 1 with respect to other components of the HBOT hyperbaric chamber 2.

To improve transportability, it is preferably provided that the shell 1 has, in at least one direction, an outer contour smaller than a rectangle having dimensions of 80 cm×200 cm. This rectangle is indicated by dashed lines in the drawing. This sizing enables the shell 1 to be transported through a standard door.

1. A shell for forming a pressurised part of an HBOT hyperbaric chamber, i.e. an HBOT hyperbaric chamber for performing hyperbaric oxygen therapy for a person at an operating pressure of 1.3 to 2 bar overpressure,
wherein a shell-shaped support lattice is provided;
wherein the support lattice has a plurality of support strips extending along the shell shape and a plurality of openings kept free between the support strips;
wherein a transparent window shell is provided which is held on its outer face by the support lattice and pressure-tightly covers the openings of the support lattice, in particular all openings of the support lattice.

2. The shell according to claim 1, wherein
the window shell is configured as a continuous shell-shaped window shell;
and the window shell is adapted to the shape of the support lattice and extends along the shell shape of the support lattice.

3. The shell according to claim 1, wherein the window shell is supported on its outer face on the support lattice along the support strips against a pressure force acting on the inside of the window shell.

4. The shell according to claim 1, wherein a functional ring is provided at the edge of the shell, at which the edge of the support lattice engages.

5. The shell according to claim 4, wherein the window shell and the support lattice protrude from the functional ring on one side;
and, within the shell-shaped composite structure comprising the functional ring, the window shell and the support lattice, a shell interior space is kept clear.

6. The shell according to claim 5, characterised
in that, in the region of the functional ring, the shell interior space has a free interior space of at least 110 cm×110 cm, preferably 130 cm×130 cm;
and/or in that in the region of the functional ring, the shell interior space has a free inner diameter of at least 160 cm, preferably 180 cm.

7. The shell according to claim 1, wherein
the shell has an outer contour in at least one direction, which is smaller than a rectangle having dimensions of 80 cm×200 cm;
and/or the shell is dimensioned in such a way that it passes through a rectangular opening having dimensions of 80 cm×200 cm.

8. The shell according to claim 1, wherein
the support strips of the support lattice extend in a basket-like pattern;
and/or the support strips of the support lattice extend in a star-shaped pattern;
and/or the support strips of the support lattice extend along planes of symmetry of the shell shape.

9. The shell according to claim 1, wherein the shell has the form of a body of revolution or of a part of a body of revolution.

10. The shell according to claim 1, wherein
a sealing assembly is provided;
and the window shell, the support lattice, the functional ring and the sealing assembly together form a composite structure that bears the overpressure in the HBOT hyperbaric chamber.

11. The shell according to claim 1, wherein the window shell is a shell-shaped laminated pane.

12. The shell according to claim 1, wherein it is configured as a door for an HBOT hyperbaric chamber.

13. An HBOT hyperbaric chamber with an operating pressure of 1.3 to 2 bar overpressure, wherein a pressurised part is configured as a shell according to claim 1.

14. The HBOT hyperbaric chamber according to claim 13, wherein a source of overpressure, such as in particular a compressor, is provided for generating an operating pressure of the HBOT hyperbaric chamber from 1.3 to 2 bar overpressure.

15. The HBOT hyperbaric chamber according to claim 13, wherein inside the HBOT hyperbaric chamber a seat arranged or arrangeable for the seated positioning of a person inside the HBOT hyperbaric chamber is provided.

16. The HBOT hyperbaric chamber according to claim 13, wherein
an oxygen source,
an oxygen delivery device, in particular an oxygen mask,
and an oxygen line conducting oxygen from the oxygen source to the oxygen delivery device are provided.

17. The HBOT hyperbaric chamber according to claim 16, wherein
the oxygen source is placed outside of the HBOT hyperbaric chamber;
and the oxygen delivery device, in particular the oxygen mask, is arranged inside the HBOT hyperbaric chamber.

18. The HBOT hyperbaric chamber according to claim 17, wherein the oxygen line runs from the oxygen source through the shell, in particular through the functional ring of the shell, to the oxygen delivery device.

19. The HBOT hyperbaric chamber according to claim 16, wherein the oxygen source and the oxygen line deliver the oxygen within the HBOT hyperbaric chamber exclusively via the oxygen delivery device, preferably directly to the mouth and/or nose of the person located in the HBOT hyperbaric chamber.

20. The HBOT hyperbaric chamber according to claim 1, wherein the HBOT hyperbaric chamber and the shell withstand a test pressure of at least 2.86 bar overpressure and/or are designed for a test pressure of at least 2.86 bar overpressure.

21. The HBOT hyperbaric chamber according to claim 1, wherein a base module is provided, on which the shell is movably mounted.

22. The HBOT hyperbaric chamber according to claim 1, wherein
two shells according to claim 1 are provided,
and the two shells, in particular their functional rings, are connected in a sealing manner to form the HBOT hyperbaric chamber.
